(19) United States
(12) Patent Application Publication
(10) Pub. No.: US 2008/0144601 A1
(43) Pub. Date: Jun. 19, 2008

(54) SYSTEMS, METHODS, DEVICES, AND COMPUTER PROGRAM PRODUCTS PROVIDING DATA REPLICATION FOR MOBILE TERMINALS

(75) Inventors: Jukka K. Nurminen, Espoo (FI); Norbert Gyorbiro, Budapest (HU); Gabor Marton, Budapest (HU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/612,301

(22) Filed: Dec. 18, 2006

(51) Int. Cl. H04J 3/06

(52) U.S. Cl. 370/350

(57) ABSTRACT

Systems, methods, devices, and computer program products are provided for synchronizing replicated databases in an intelligent way in order to utilize the advantages of the of the different types of connections that may be available to the electronic devices in the data replication system. In this regard, the transfer of synchronization items from a first electronic device to a second electronic device may be based on characteristics of the synchronization items and characteristics of the available connectivity states of the first electronic device.

### FIELD OF THE INVENTION

Embodiments of the invention relate generally to data replication systems and, more particularly, relate to a system for synchronizing replicated databases in a mobile environment.

### BACKGROUND OF THE INVENTION

Mobile phones are increasingly used for executing mobile software applications. Many such applications require that the phone be able to access data from a remote server. Since connectivity to the remote server may not always be possible and since any connection may be limited, at least a portion of the data may be replicated to the mobile device. The problem of data replication on mobile devices has been studied quite extensively. In most cases, the research directed to data replication on mobile terminals has focused on nomadic cases where the mobile device is either connected to the remote server or is not connected to the remote server. In other words, traditional data replication systems utilize a two-state connectivity model, where the mobile device is either connected to the remote server such that the replicated database in the mobile terminal can be synchronized or not connected to the remote server such that the replicated database cannot be synchronized.

Such traditional two state replication systems ignore important capabilities of modern mobile phones. For example, in countries with well-developed infrastructure, a mobile phone is able to have an almost constant connection to a communication network. For example, a mobile phone in a developed area has almost constant access to a cellular communication system, such as General Packet Radio Services (GPRS) system. Typically, however, such a connection is limited in bandwidth and is expensive to use relative to other types of data connections. On the other hand, when the phone enters an area, such as a “hotspot,” where a wireless local area network (WLAN) provides access to the Internet, a large bandwidth may be available that is relatively inexpensive, if not free of charge.

Thus, it would be advantageous if a solution were developed that better utilized the different types of connections available to modern mobile phones in order to create a database replication system that is more efficient with respect to the cost and speed of synchronization. It would also be advantageous if such a solution was provided for improved data replication between any sites of a distributed database system using optimistic replication.

### BRIEF SUMMARY OF THE INVENTION

In one embodiment of the present invention, a computer program product is provided for providing data synchronization between replicated databases in a first device and a second device. The computer program product comprises at least one computer-readable storage medium having computer-readable program code portions stored therein. The computer-readable program code portions may include: a first executable portion for determining a priority level for a synchronization item; a second executable portion for determining a current state of the first device, wherein the current state comprises one of at least three possible states of the first device, the at least three possible states of the first device being at least partially based on a connection between the first device and the second device; and a third executable portion for communicating the synchronization item from the first device to the second device based at least partially on the state of the first device and the priority level of the synchronization item.

The second executable portion of the computer program product may be configured to determine the current state from among: a first connection state where the first device is not connected to the second device; a second connection state where the first device is connected to the second device using a first connection; and a third connection state where the first device is connected to the second device using a second connection that is different than the first connection.

The current state may be based at least partially on the type of the connection between the first and second devices, and the first connection may include a first type of connection that is generally slower and/or more expensive than a second type of connection that makes up the second connection. The current state of the device may be based at least partially on the transmission rate of the connection between the first and second devices, and the first connection may have a lower transmission rate than the second connection. The current state of the device may be based at least partially on the cost of the connection between the first and second devices, and the first connection may have a higher cost than the second connection.

The first connection may involve using a first communication interface of the first device for connecting to a cellular network and the second connection may involve using a second different communication interface for connecting to a wireless local area network. The priority level may be at least partially based on the size of the synchronization item.

The first executable portion of the computer program product may include an executable portion for determining a priority threshold and for determining a relationship of the priority level of the synchronization item to the priority threshold in order to classify the synchronization item as being of a first priority or a second priority. The third executable portion may then be configured to queue the synchronization item for communication using the first connection if the priority level indicates the first priority. The third executable portion may be further configured to queue the synchronization item for communication using the second connection if the priority level indicates the second priority. The first executable portion may be configured to determine the priority level for the synchronization item by basing the priority level at least partially on the size of the synchronization item and then adjusting the priority level based on externally originated commands. The priority threshold may be determined based on externally originated commands.

Where the first executable portion of the computer program product includes an executable portion for determining a priority threshold and for determining a relationship of the priority level of the synchronization item to the priority threshold in order to classify the synchronization item as being of a first priority or a second priority, the third executable portion may be configured so that the synchronization item is not communicated using the first connection if the priority level of the synchronization item indicates the first priority. The third executable portion may be further configured so that the synchronization item is communicated using the first connection if the priority level of the synchronization item indicates the second priority. The third executable portion may be configured to communicate metadata related to the synchronization item using the first connection if the priority level of the synchronization item indicates the first priority. The metadata may include an abbreviated version of the synchronization item. The third executable portion may be configured so that the synchronization item is queued to be sent using the second connection if the priority level of the synchronization item indicates the first priority.

The computer program product may also include a fourth executable portion for receiving input from an external entity, the input requesting communication of the synchronization item using the first connection, and for overriding the third executable portion such that the synchronization item is communicated using the first connection despite the fact that the priority level of the synchronization item indicated the first priority prior to receipt of the input.

The first device may be embodied as a mobile terminal and the second device may be embodied as a server, or the first device and the second device may each be embodied as a mobile terminal. In yet another embodiment, the first device and the second devices may each be embodied as a server.

In one embodiment, a method is provided for providing data synchronization between replicated databases in a first device and a second device. The method may include: determining a priority level for a synchronization item; determining a current state of the first device, wherein the current state comprises one of at least three possible states of the first device, the at least three possible states of the first device being at least partially based on a connection between the first device and the second device; and communicating the synchronization item from the first device to the second device based at least partially on the state of the first device and the priority level of the synchronization item.

In another embodiment of the present invention, an apparatus is provided. The apparatus may include: a memory for storing a replicated database and a synchronization item; at least one communication interface for establishing a connection with an electronic device and for communicating the synchronization item to the electronic device; and a processor operatively coupled to the memory and the communication interface. The processor may be configured to: determine a priority level for the synchronization item; determine a current state of the apparatus, wherein the current state comprises one of at least three possible states of the apparatus, the at least three possible states of the apparatus being at least partially based on the connection between the apparatus and the electronic device; and communicate the synchronization item from the memory to the electronic device based at least partially on the current state of the apparatus and the priority level of the synchronization item.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal in accordance with one embodiment of the present invention;

FIG. 2 is a schematic block diagram of one type of system that may benefit from embodiments of the present invention;

FIG. 3 is an illustration of a data replication system in accordance with one embodiment of the present invention;

FIG. 4 is an illustration of a synchronization scheme that provides for data synchronization based on the connection state of the mobile terminal and the priority of the synchronization item stored in the mobile terminal, in accordance with one embodiment of the present invention;

FIG. 5 is a flowchart illustrating a process of communicating synchronization items using the synchronization scheme illustrated in FIG. 4, in accordance with one embodiment of the present invention; and

FIG. 6 is a schematic block diagram illustrating process and data flows during a process of synchronizing replicated databases between two electronic devices in accordance with one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

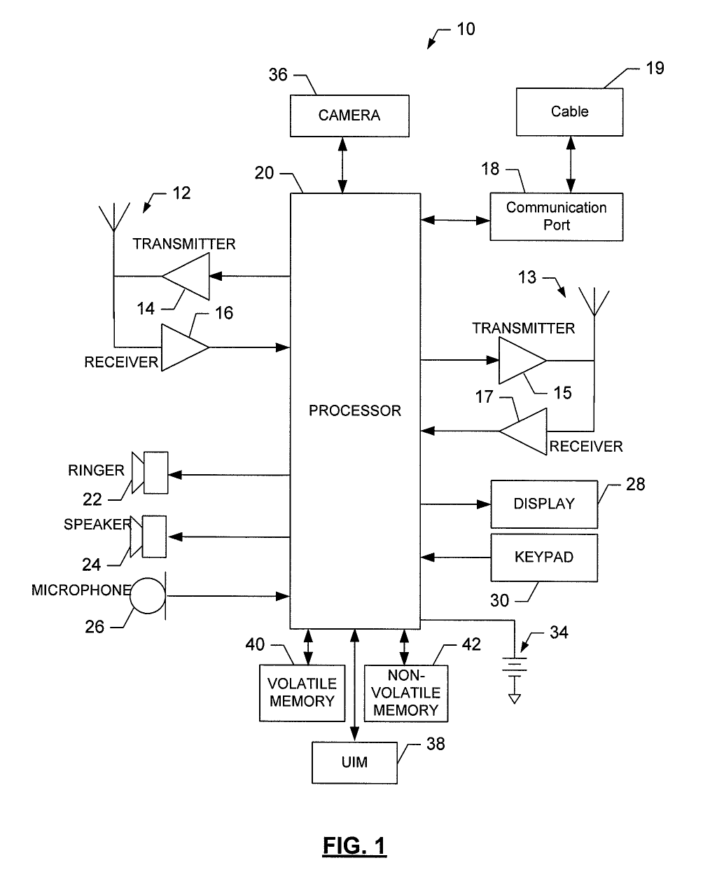

FIG. 1 illustrates a block diagram of a mobile terminal 10 that may benefit from embodiments of the present invention. Although FIG. 1 illustrates a mobile telephone as the mobile terminal 10, it should be understood that a mobile telephone is merely illustrative of one type of mobile terminal that could be used with embodiments of the present invention. While several embodiments of the mobile terminal 10 are illustrated and will be hereinafter described for purposes of example, other types of mobile terminals, such as digital cameras, portable digital assistants (PDAs), pagers, mobile televisions or video players, mobile computers, laptop computers, mp3 players, satellite radio units, mobile video game consoles, and other types of systems that manipulate and/or store data files, can readily employ embodiments of the present invention. Such devices may or may not be mobile.

The mobile terminal 10 includes a communication interface comprising an antenna 12 in operable communication with a transmitter 14 and a receiver 16. The mobile terminal 10 further includes a processor 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

The communication interface of the mobile terminal 10 may also include a second antenna 13, a second transmitter 15, and a second receiver 17. The processor 20 also provides signals to and receives signals from the second transmitter 15 and second receiver 17, respectively. The second antenna 13, transmitter 15, and receiver 17 may be used to communicate directly with other electronic devices, such as other compatible mobile terminals. The mobile terminal 10 may be configured to use the second antenna 13, transmitter 15, and receiver 17 to communicate with other electronic devices in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like.

The mobile terminal 10 may further include a communication interface comprising a communication port 18 configured to be permanently or removably connected to a cable 19 that can be used to connect the mobile terminal 10 to other electronic devices. The processor 20 may provide signals to and receive signals from the communication port 18. The mobile terminal 10 may be configured to use the communication port 18 and the cable 19 to communicate with other electronic devices. The mobile terminal 10 and the cable 19 may be structured so that data and/or power may be communicated between the mobile terminal 10 and the other electronic device. For example, in one embodiment, the cable 19 comprises a Universal Serial Bus (USB) cable having data wires, a power wire, and a ground wire. Power received through the cable 19 may be used by the mobile terminal 10 to power various components of the device and/or charge a battery 34.

It is understood that the processor 20 includes circuitry required for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 can additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In one embodiment, the mobile terminal 10 includes a headset (not shown). The headset may comprise a speaker and/or a microphone that may be used in addition to or as an alternative to speaker 24 and microphone 26. The headset may be wired to the mobile terminal 10 or the headset may be configured to wirelessly communicate with the mobile terminal 10 through one of the mobile terminal's communication interfaces. In one embodiment, the mobile terminal may use Bluetooth® wireless technology to communicate with the wireless headset. Bluetoothφ is an open radio-frequency standard that enables cable-free voice and data communication between devices through short-range two-way radio (in the radio frequency range of 2.45 gigahertz).

In an exemplary embodiment, the mobile terminal 10 includes a camera 36 in communication with the processor 20. The camera 36 may be any means for capturing an image for storage, display or transmission. For example, the camera 36 may include a digital camera capable of forming a digital image file from a captured image. As such, the camera 36 includes all hardware, such as a lens or other optical device, and software necessary for creating a digital image file from a captured image. Alternatively, the camera 36 may include only the hardware needed to view an image, while a memory device of the mobile terminal 10 stores instructions for execution by the processor 20 in the form of software necessary to create a digital image file from a captured image. In an exemplary embodiment, the camera 36 may further include a processing element such as a co-processor which assists the processor 20 in processing image data and an encoder and/or decoder for compressing and/or decompressing image data. The encoder and/or decoder may encode and/or decode according to a JPEG or an MPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

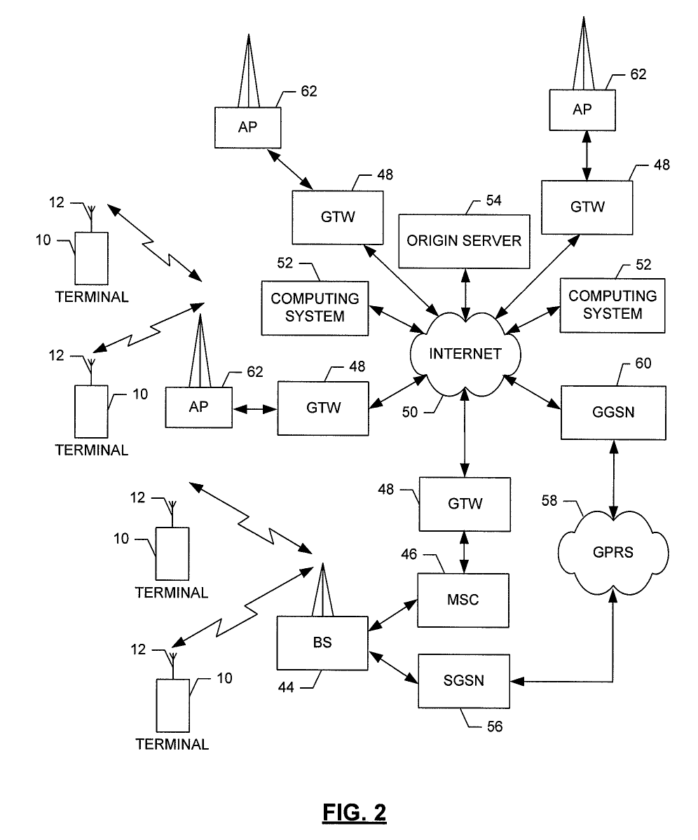

Referring now to FIG. 2, an illustration is provided of one type of system in which embodiments of the present invention may be configured to operate. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

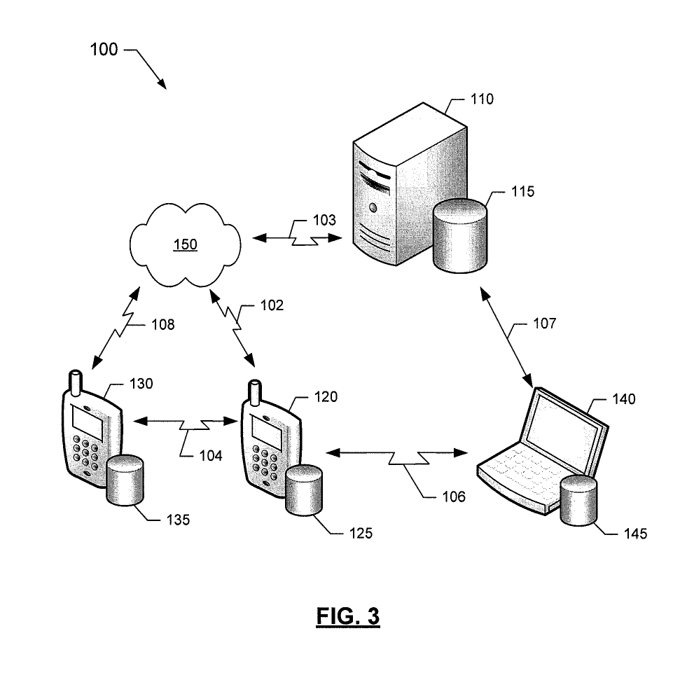

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 3), origin server 54 (one shown in FIG. 3) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-genaration (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

Referring now to FIG. 3, an illustration is provided of a data replication system 100 in accordance with one embodiment of the present invention. In particular, FIG. 3 illustrates the different connectivity options that may be available to a first mobile terminal 120 for communicating synchronization data to other electronic devices, such as a server 110 or a second mobile terminal 130, in accordance with one embodiment of the present invention. The first mobile terminal 120 and the second mobile terminal 130 may be similar to the mobile terminal 10 described above with respect to FIG. 1. Although FIG. 3 shows two mobile terminals in the data replication system 100, other embodiments of the data replication system may include more or less than two mobile terminals.

In the illustrated embodiment, a server 110 comprises a main database 115. The first mobile terminal 120 and a second mobile terminal 130 each have at least a portion of the main database 115 replicated in a first replicated database 125 and a second replicated database 135, respectively. In general, when changes (e.g., insertions, updates, and deletions) are made to a replicated database on one of the mobile terminals, synchronization items containing each change are communicated to the server 110 and other mobile terminals and electronic devices in the system such that the main database and the other replicated databases can be updated accordingly. Although FIG. 3 illustrates a server 110 having a main database 115 stored therein, other embodiments of the present invention may be purely peer-to-peer in that there may be no main or centralized database 115. Instead, in such a peer-to-peer system the database may be distributed over a plurality of electronic devices, such as the mobile terminals 120 and 130. Likewise, although FIG. 3 illustrates a data replication system having at least two mobile terminals that can communicate directly to each other, other embodiments of the present invention may be purely client-server data replication systems where a client device only synchronizes its database with the database on a server device. Still other embodiments of the present invention may include multiple servers and each server may be configured to communicate with one or more other servers using the same principles described herein with respect to the mobile terminals.

In the illustrated embodiment, the first mobile terminal 120 is equipped with a communication interface that allows the mobile terminal 120 to synchronize changes in the replicated database 125 with the databases in other electronic devices using at least two different types of data transmission systems. For example, the first mobile terminal 120 may be configured to communicate database information with another electronic device using either a first data transmission system or a second different data transmission system, depending on which data transmission system, if any, is available to the first mobile terminal 120. In one embodiment, the mobile terminal 120 uses a first communication interface of the mobile terminal to use the first data transmission system and a second communication interface of the mobile terminal to use the second data transmission system. In this regard, the first mobile terminal 120 may have at least three connectivity states: a first connectivity state when there is no data transmission system available that the first mobile terminal 120 is configured to utilize; a second connectivity state when the first mobile terminal 120 is connected to a first data transmission system; and a third connectivity state when the first mobile terminal 120 is connected to a second data transmission system. Embodiments of the present invention may communicate different synchronization items in different ways depending on the current connectivity state of the mobile terminal 120. Although the mobile terminals described herein generally are described as having three connectivity states, other embodiments of the mobile terminals may have more than three connectivity states and may connect to other devices using more than two different types of data transmission systems.

In the exemplary embodiment illustrated in FIG. 3, the mobile terminal 120 is configured to use either a first or a second data transmission system when communicating changes made to the first replicated database 125 of the first mobile terminal 120 to the server 110 so that the server 110 may incorporate these changes in the main database 115. More particularly, the first data transmission system comprises the first mobile terminal 120 establishing a data connection 102 to a communication network 150. Since the server 110 is also connected to the communication network 150 by data connection 103, the mobile terminal 120 may communicate with the server 110 via the communication network 150. In one embodiment, the communication network 150 includes a cellular network using, for example, a GPRS or a GSM system. In other embodiments, other wide-area or global-area networks are used that the first mobile terminal 120 is configured to access using its communication interface.

The second data transmission system in the illustrated embodiment of FIG. 3 includes the first mobile terminal 120 using a second different communication interface of the first mobile terminal 120 to establish a connection 106 to an intermediate electronic device 140. Since the intermediate electronic device 140 is connected to the server 110 by a data connection 107, the first mobile terminal 120 may communicate with the server 110 via the intermediate device 140. In one embodiment, the connection 107 between the intermediate device 140 and the server 110 includes a direct wireline or wireless connection from the intermediate device 140 to the server 110. In other embodiments, the connection 107 includes one or more other communication networks for communicating information to the server 110. For example, the intermediary device 140 and the server 110 may each comprise an ADSL connection to the Internet, allowing for relatively fast communication between the intermediary device and the server 110. The connection 106 between the first mobile terminal 120 and the intermediate device 140 may include a USB-type connection, an RF connection, a Bluetooth® connection, or other wireline or wireless connection. In one embodiment, the intermediate device 140 comprises a wireless router or access point that creates a WLAN that the first mobile terminal 120 may use to gain access to the server 110 via the data connection 107. In another embodiment, the intermediate device 140 comprises a PC or some other electronic device that has a communication interface that the first mobile terminal 120 may couple with using a wireless or wireline connection 106. The first mobile terminal 120 may then communicate with the server through the PC or other device, since the PC or other device is connected to the server 110 via connection 107. The intermediate device 140 may or may not have a replicated database 145 stored therein.

In the illustrated embodiment, the first mobile terminal 120 may connect to other electronic devices, such as a second mobile terminal 130, in order to synchronize the first mobile terminal's database 125 with the second mobile terminal's database 135. As with communicating with the server 110, the first mobile terminal 120 may be configured to communicate with the second mobile terminal 130 using more than one data transmission system. For example, the mobile terminal may be configured to communicate to the second mobile terminal 130 via the communication network 150, which may include a cellular network using, for example, a GPRS or GSM system. The first mobile terminal 120 may also be configured to communicate with the second mobile terminal 130 using a second data connection 104. The second data connection 104 may be a wireline or a wireless connection and may comprise, for example, a Bluetooth® connection, a USB-type connection, an RF connection, and infrared connection, and the like. In one embodiment, the data connection 104 is the same type of connection as the data connection 106, and the first mobile terminal 120 may make the connections 104 and 106 using the same communication interface of the first mobile terminal 120. In some embodiments, the second mobile terminal 130 may also receive the changes made in the first mobile terminal's database by synchronizing the second mobile terminal's database 135 with the server's main database 115 after the first mobile terminal 120 synchronizes with the server 110.

Where the first mobile terminal 120 is configured to communicate with other electronic devices using at least two data transfer systems, one data transfer system is generally more desirable than the others for performing certain data transmission tasks. For example, in the system of FIG. 3 the first mobile terminal 120 may be configured to have a first communication interface that allows the mobile terminal to connect to a cellular network 150 as a first data transmission system for communicating with other electronic devices. The first mobile terminal 120 may further be configured to have a second communication interface that allows the first mobile terminal 120 to connect to other electronic devices using a Bluetooth(V connection or some other WLAN. The advantage of the cellular network connection is that the cellular network connection is generally available almost all the time, regardless of where the mobile terminal is located. The disadvantage to the cellular network connection, however, is that it is typically expensive to use relative to other data communication systems. For example, the costs of using a cellular network are often based on the amount of time that cellular network was used. Furthermore, the cellular networks typically have low data transmission rates compared to LANs and WLANs. As a result, it is generally expensive and may take a long time to send large amounts of data, such as a high resolution digital picture, over a cellular network. Bluetooth®, USB, WLAN connections, or other connections that are sometimes available for connecting to the Internet or to other electronic devices, are often free and considerably faster than a cellular network connection. Therefore, while the cellular network may be advantageous in some situations since the cellular network may provide for the synchronization of all of the replicated databases at almost any time, for communicating large amounts of data, such as large synchronization items, it may be too expensive and too time consuming to use the cellular network. For these large synchronization items, the fast and often free Bluetooth® or WLAN connections would be preferable.

Therefore, embodiments of the present invention provide a system of synchronizing replicated databases in an intelligent way in order to utilize the advantages of the different types of connections that may be available to the electronic devices in the data replication system. In this regard, embodiments of the present invention provide for the transfer of synchronization items from a first electronic device to a second electronic device based on characteristics of the synchronization items and characteristics of the available connectivity states of the first electronic device. As described above, relevant characteristics of the connectivity states may include cost and data transmission rates. Other relevant characteristics of the connectivity states may include, for example, battery consumption, reliability, and the permanence of the connection.

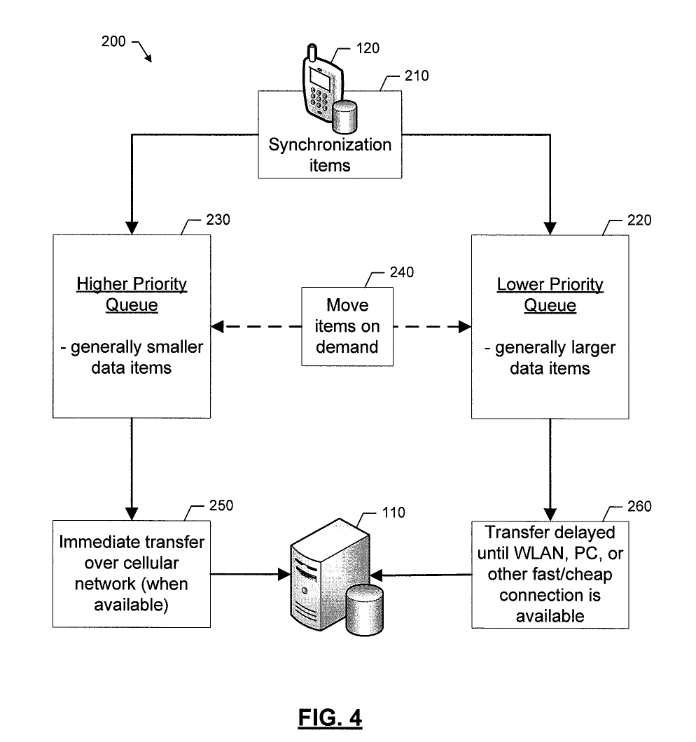

FIG. 4 illustrates a conceptual diagram of how one embodiment of the present invention may work with regard to the data replication system described in FIG. 3. As described above, changes occurring to the replicated database 125 of the first mobile terminal 120 are accumulated in a memory of the first mobile terminal 120 as synchronization items 210. As depicted in FIG. 4, the synchronization items 210 are sorted by the processor of the first mobile terminal 120 into two separate queues based on a predetermined rule. For example, in the illustrated embodiment, the synchronization items are sorted (at least initially) based on the size of each synchronization item. For example, generally small synchronization items are placed into a higher priority queue 230 and generally large synchronization items are placed into a lower priority queue 220. As described below, large and small may be defined based on a predefined size threshold with items larger than the predefined threshold being considered large synchronization items and items smaller than the predefined threshold being considered small synchronization items. Synchronization items in the higher priority queue 230 may be transferred immediately to the server 110 over the cellular network, as represented by block 250, assuming the cellular network is available and a cheaper and faster connection is not presently available to the first mobile terminal 120. Synchronization items in the lower priority queue 220, however, are not transferred to the server 110 immediately over the relatively slow and expensive cellular network and are instead held in the queue until a faster and/or cheaper connection becomes available to the mobile terminal 120, as represented by block 260. In one embodiment, the mobile terminal 120 keeps track of the amount of time a synchronization item is in the lower queue 220 and, if the time exceeds some maximum time without the cheaper or faster connection becoming available, the mobile terminal 120 may automatically send the synchronization item via the cellular network or may ask the user if the item should be sent via the cellular network. Although FIG. 3 shows the first mobile terminal 120 communicating synchronization items to the server 110, the same priority system can be used to communicate synchronization items to other electronic devices, such as the second mobile terminal 130.

In one embodiment, a priority level is determined for each synchronization item and the synchronization items are sorted by comparing the determined priority level for each synchronization item to a threshold priority level. The priority level and the priority threshold may be determined by the processor without user input or may be determined based on user input. Even where the priority level and the priority threshold are determined automatically by the mobile terminal's processor, the priority level and/or the priority threshold may be subsequently adjusted by user input, in accordance with one embodiment of the present invention.

In one embodiment, the priority level for each synchronization item is the size of the synchronization item and the priority threshold is a threshold size. In such an embodiment, for synchronization items where the size of a synchronization item is below the threshold size, the synchronization item is placed in the higher priority queue and, for synchronization items where the size of a synchronization item is above the threshold size, the synchronization item is placed in the lower priority queue. In other embodiments, integers are assigned to each synchronization item, the integers representing the priority level of the synchronization item or whether the synchronization item is a higher priority item or a lower priority item. For example, all high priority items may be assigned a zero and all low priority items may be assigned a one. In another example, each item may be assigned an integer based on its size, such as an integer from 1-10 with 1 representing a very small item and 10 representing a very large item. Items having an integer of 1-4 associated with them, for example, may be placed in the higher priority queue 230, while items with integers of 5-10 associated with them may be placed in a lower priority queue 220. The priority of an item, such as the integer value associated with an item, may be based at least partially on the size of the synchronization item and/or at least partially on user input.

In other embodiments, the priority level may be based on the type of synchronization item or the application that created or can use the synchronization item. In still other embodiments, the priority level may be specified by a user of the first mobile terminal or the second mobile terminal or may be voted on by a plurality of users. In some embodiments, the priority level is a property of a column in a database table.

Note that, when it is said herein, for example, that a first synchronization item has a “higher” priority than a second synchronization item, it does not mean that the integer or other value used as the priority level for the first synchronization item is necessarily greater than the integer or value used as the priority level for the second synchronization item. In some embodiments, the lower the integer used for the priority level, the higher the priority of synchronization item associated with the lower integer. For example, where the priority level is the size of the synchronization item, the smaller the size of a synchronization item, generally the higher the priority of the synchronization item.

In one embodiment of the present invention, synchronization items may be moved from the lower priority queue to the higher priority queue and vice versa on demand, as illustrated by block 240 in FIG. 4. The demand may be received by the first mobile terminal 120 in input received from some external entity, such as the user of the first mobile terminal 120 or another electronic device. For example, the user of the first mobile terminal 120 may command the processor to move a synchronization item from one queue to another. In one embodiment, a signal received from an external electronic device may command the processor of the first mobile terminal 120 to move a synchronization item from one queue to another. According to one embodiment, the synchronization item may be moved from one queue to another by changing the priority level associated with the synchronization item. In another embodiment, the priority threshold may be changed by the demand.

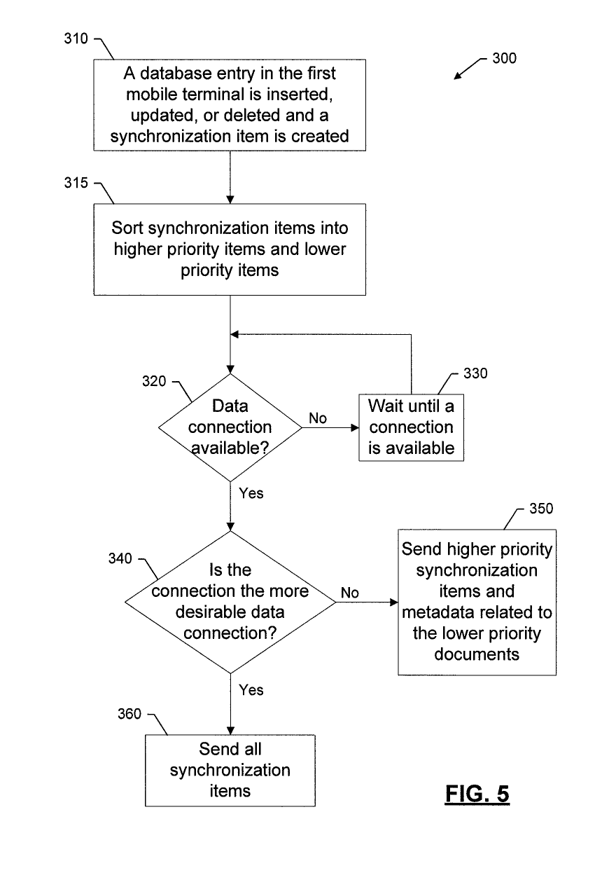

FIG. 5 illustrates a general procedure 300 for communicating a synchronization item from the first mobile terminal 120 to a second electronic device, in accordance with one embodiment of the present invention. As represented by block 310, a synchronization item is created when a database entry in the first mobile terminal 120 is inserted, updated, or deleted. The synchronization items are then sorted into higher priority synchronization items and lower priority synchronization items, as illustrated by block 315 and as described above with regard to FIG. 4.

The processor of the first mobile terminal 120 then determines the connectivity state of the first mobile terminal 120 and communicates synchronization items based on the connectivity state of the first mobile terminal 120 and the priority of the synchronization items. In this regard, the processor determines whether a data connection is available, as illustrated by block 320. If no data connection is available, then the mobile terminal is in a first connectivity state in which no synchronization items can be communicated. In such a state, the processor of the mobile terminal 120 waits until a data connection becomes available, as illustrated by block 330.

Where a data connection is available, the processor determines whether the available connection(s) includes a first data connection or a second “more desirable” data connection, as illustrated by block 340. For example, as described above, where the first mobile terminal 120 is configured to be able to communicate data to another electronic device using either a cellular network or a faster and less expensive WLAN, the faster and less expensive WLAN is generally the more desirable connection to use when it is available. If the second more desirable data connection is not available, then the first mobile terminal 120 sends the higher priority synchronization items to the other electronic device using the first data connection, as illustrated by block 350. However, where only the first connection is available, the first mobile terminal 120 does not communicate the lower priority synchronization items to the other electronic device, unless, as described above, the priority system is overridden for one or more synchronization items based on a demand from the mobile terminal user or from an external electronic device.

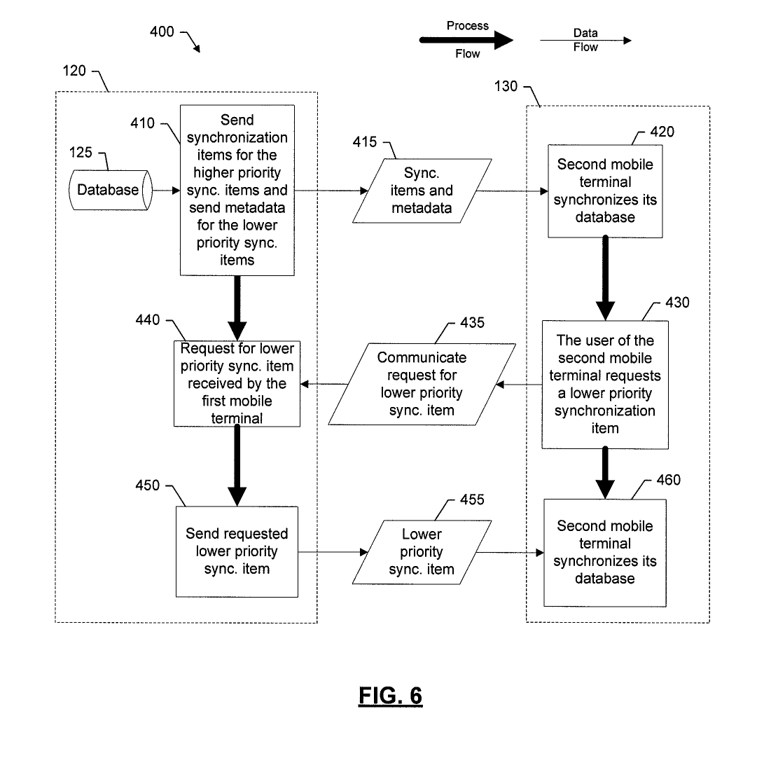

Although the mobile terminal 120 generally does not send the lower priority synchronization items using the first less desirable data connection, in one embodiment of the present invention, the mobile terminal 120 is configured to send metadata related to the lower priority synchronization items to the other electronic device using the first less desirable data connection, as also illustrated by block 350. For example, the metadata may simply include an indication that a database entry has been inserted, updated, or deleted. In another example, the metadata may include a description of the inserted data, the update, or the deletion. In yet another example, the metadata may include a compressed or an otherwise abbreviated version of the synchronization item. The idea behind sending metadata is to create a smaller object from the large synchronization item that can be transferred using the first less desirable connection without adding considerable extra cost. Then, at a later time when the second more desirable connection becomes available, the original synchronization item can be transferred to the other electronic device. In this regard, where metadata related to a lower priority synchronization item is communicated using the first less desirable data connection, the lower priority synchronization item is still generally queued for transmission via the second more desirable data connection when such a data connection becomes available. As is described below in relation to FIG. 6, in one embodiment, once metadata is sent, the mobile terminal may receive an externally originated request for the item that may cause the mobile terminal to transfer the item even over the slower and/or more costly network. In one embodiment, the metadata provides a user of an external device the option of requesting the item over the slower and/or more costly network.

In one embodiment, generic or application specific compressors/data extractors may be utilized for generating abbreviated versions of the synchronization item. For example, if a large image was added to the first mobile terminal's database 125, a generic image compressor component may be used to create a scaled-down version of the image. This scaled-down version may be sent to the other electronic device. Likewise, if the image includes annotation information or other metadata, such information may also be inserted in the scaled-down version. Where the synchronization item contains, for example, a large document where the format is dictated by a particular application, then the application may be used to provide an extractor that extracts the portions of the document so that the document portions may be transferred via a first less desirable connection. In this way, although the abbreviated representation of the document does not contain all the details of the large original field, it can still be interpreted by the application without any modifications to its logic. Application specific compressors and extractors may be embodied as software, such as software written in a plug-in like manner, provided in stored procedures, or provided in higher level languages than the synchronization script. Such compressors and extractors may be automatically called by the synchronization script. The creation of a smaller representation of the large synchronization data is sometimes referred to herein as the “deferral” of the data.

Referring again to FIG. 5, if the second more desirable data connection, such as a faster and less expensive WLAN, is available to the first mobile terminal 120, the first mobile terminal 120 may then send all of the synchronization items (both lower and higher priority items) to the other electronic device, as illustrated by block 360. In one embodiment, the lower priority synchronization items are communicated first so that the generally larger-sized lower priority items are communicated quickly before the second more desirable data connection is no longer available. In other embodiments, the higher priority synchronization items are communicated first. In yet another embodiment, all of the priority items are communicated at substantially the same time or are communicated in the order that the synchronization items were generated by the first mobile terminal 120.

FIG. 6 illustrates how a first electronic device, such as the first mobile terminal 120, may communicate synchronization items to another electronic device, such as the second mobile terminal 130, using the priority system of FIG. 4 and how the other electronic device may request to override the priority system. FIG. 6 illustrates the process flow in each mobile terminal as well as the data flow between the two mobile terminals. As described above, the first mobile terminal 120 accumulates synchronization items based on insertions, updates, and deletions to its replicated database 125. As also described above and as represented by block 410, when only the less desirable data connection is available, the first mobile terminal 120 sends the higher priority synchronization items to the other electronic device and may not send the lower priority synchronization items. In one embodiment, however, the first mobile terminal 120 may send metadata related to the lower priority synchronization items. In this regard, the higher priority synchronization items and metadata related to the lower priority synchronization items 415 may be communicated to the other electronic device, such as the second mobile terminal 130.

The second mobile terminal 130 receives the higher priority synchronization items as well as the metadata for the lower priority synchronization items and updates the replicated database 135 stored in the memory of the second mobile terminal 130, as illustrated by block 420. If the user of second mobile terminal 130, after viewing the metadata related to the lower priority synchronization items, decides that he or she would like the lower priority synchronization items communicated to the second mobile terminal 130 without waiting until the first mobile terminal 120 finds a more desirable data connection, then the user may communicate a request 435 to the first mobile terminal 120 for immediate transmission of a lower priority synchronization item, as represented by block 430. The first mobile terminal 120 may receive this request 435, as represented by block 440, and, in response to the request, send the requested lower priority synchronization item 455 to the recipient device, as represented by block 450. The second mobile terminal 130 receives the requested lower priority synchronization item and updates its database 135 accordingly.

In one embodiment of the system described in FIG. 6, the user of the first mobile terminal 120 receives the request for the lower priority synchronization item and manually changes the priority level of the requested synchronization item or otherwise manually overrides the priority system executed by the processor of the first mobile terminal 120. In another embodiment of the system, the request 435 from the second mobile terminal 130 commands the first mobile terminal processor to change the priority of the requested lower priority synchronization item or to otherwise override the priority system and communicate the requested lower priority synchronization item to the second mobile terminal.

Having thus described embodiments of the present invention in general terms, one embodiment of the present invention is described below with regards to one exemplary application of the system. In this regard, in one embodiment of the invention, the data replication system is configured to be used in the real estate industry by a real estate agency. The real estate agency may have a server with a database stored therein. The database may comprise listings of homes that are for sale. Each real estate agent that works for the real estate agency may have a mobile terminal, such as mobile terminal 120, in which the real estate agent can store at least a portion of the main database as a replicated database.

The communication needs of real estate agents are high since communicating with the customers is a key part of the work and since they are often on the move. Access to property and customer information is important for efficient real estate work and the need for access to such information often arises abruptly when a customer calls. As such it is important for the real estate agent to be able to access the data anytime and anywhere.

Supposing for example that a real estate agent is visiting a customer in order to collect data about the house the customer would like to sell. The customer data is already available in the real estate database, however, during the real estate agent's visit to the house, the real estate agent collects detailed data and takes digital photos of the house. This data should be updated to the database. Meanwhile, a marketing employee of the real estate agency is creating a brochure of houses that have recently come onto the market. The real estate system automates a lot of the brochure creation by collecting relevant data from the real estate database. The marketing employee, however, would like to include the property the real estate agent is currently visiting, although the database does not include any of the details and pictures needed for the brochure.

It is therefore important that the data collected by the real estate go to the database immediately so that it would be available for other agents and employees, such as the marketing employee. The real estate agent, however, only currently has access to a cellular connection. As such, using embodiments of the present invention, small data items may be sent over the cellular network, such as data items like the number of bedrooms and bathrooms, the kitchen floor material, or availability of storage space in the attic. Large data items such as high quality digital pictures, however, may easily take tens of minutes to transfer using cellular networks and would be expensive. As such, embodiments of the present invention automatically schedule such larger data items so that they will be sent the next time a fast connection is available. For example, all of the new data that the real estate agent entered into her replicated database except the digital pictures may be sent immediately while the photos are uploaded only when the real estate agent later visits a suitable hotspot, for example at the office, at home, at a coffee shop, or at some other location.

A further feature of embodiments of the present invention provides the marketing employee with an indication that the real estate agent has taken digital photos even if such photos are not yet included in the main real estate database. The system may provide this indication to the marketing employee by including such an indication or other metadata in the real estate database where the digital pictures would be located. This would allow the marketing employee to decide if he can afford to wait until the system is able to upload the photos from the real estate agent's mobile terminal at a suitable hotspot or if he needs the pictures so urgently that he would like to get them (or some of them) immediately over the cellular data connection.

Furthermore embodiments of the present invention may also enhance the dissemination of changes to a distributed database by utilizing the cheap and fast, near-field communication systems such as Bluetooth®. In his regard, the real estate agents may be further allowed to synchronize between each others' replicated databases using embodiments of the present invention. Synchronization items coming from one agent can be used to synchronize with other agents as well. Such form of message propagation is often referred to a epidemic communication.

The embodiments of the present invention described above and other embodiments may be implemented in a variety of ways. For example, in one embodiment, the data replication system is implemented using the open-source SQLite database engine. SQLite contains a single executable that makes up the relational database management system (RDBMS). Using this database engine or similar database engines, the database and SQL instructions can be passed in the command line. The synchronization between the replicated databases may be handled by a single Python script. The database may be accessed from the Python language via the PySQLite interface.

In one embodiment, the synchronization method uses operation-transfer, i.e., modifying SQL statements executed locally in the database are accumulated using SQL triggers in timely order and replayed at the target replicated database upon synchronization. Tables in the database may be divided into the main data tables (perhaps created and used by the other applications) and synchronization tables needed to transfer changes to the other replicated databases. In this regard, the tables in the local database may include publication tables,

The publication tables describe which columns and rows of which main data tables should be kept synchronized. For example the script may include:

```
create table sync_publication
(
  table_name text primary key,
  condition text, -- where
  priority integer
) ;
create table sync_publication_column
(
  table_name text, -- -->sync_publication.table_name
  column_name text,
  primary key (
    table_name,
    column_name
  )
) ;
create table sync_publication_column_deferral
(
  table_name text, -- -->sync_publication_column.table_name
  column_name text, -- -->sync_publication_column.column_name
  method text,
  primary key (
    table_name,
    column_name
  )
) ;
```

In the above example, the rows of a main data table are selected by a where condition in the sync_publication table and columns are given in a separate sync_publication_column table. Each column may be marked separately for deferral (e.g., compression or abbreviation) using the sync_publication_column_deferral table and the method of deferral may also be given in this table. As described above, the method maps to a Python function that will be called by the synchronization script to create a smaller version of the possible large object. All columns that are part of the primary key would generally be published.

For every table that is offered in the publication, three synchronization tables are created representing the three basic SQL statements that can alter the rows in the tables: INSERT, UPDATE and DELETE. For every published table there are SQL triggers that are fired automatically when a table altering SQL statement is executed. These triggers will fill the synchronization tables with the following information: (1) in the case of an INSERT the values of the published columns are noted; (2) in the case of an UPDATE the new and old values of the published columns are noted; (3) in the case of DELETE the old values of the published columns are noted; and (4) in the case of an UPDATE and DELETE the stored old state may be used for conflict detection and management.

A modification of a single database row corresponds to one synchronization item. In one embodiment of the present invention, each synchronization item is uniquely identified by the following triplet: the ID of the replicated database (e.g., an ID unique to each electronic device that in the system that has a replicated database stored therein), the synchronization priority of the item, and the time of the modification. The ID is simply a name referred as peer. Each replicated database should have a unique name. As described above, the priority describes the importance of an item or some other feature of the synchronization item such as its size. For example large items are given larger numbers meaning lower priority. The time of modification may be a logical clock time that is increased every time a new synchronization item is inserted thus keeping the order of the altering instructions. The value of the clock may be handled by each peer separately.

Therefore, the synchronization items are referenced through a central sync_event table as follows:

| create table sync_event | |
|---|---|
| ( | |
| peer text, | |
| priority integer, | -- the lower the more important |
| clock integer, | |
| table_name text, | |
| type varchar(1), | -- ‘i’, ‘u’, ‘d’ |
| public integer, | -- boolean |
| primary key ( | |
| peer, | |
| priority, | |
| clock | |
| ) | |
| ) ; | |

The column table_name refers to the modified main data table and type refers to the nature of the modification (i.e., insert, update or delete). These two columns tell which synchronization table holds the particular synchronization item. The item is then located with the (peer, priority, clock) primary key triplet.

The sync_status table, shown below, is used to store the status of received synchronization items. Peers send synchronization items in synchronization packages where each item has the same priority level. Thus, a package may be identified by the (peer, priority) pair. The clock value of the latest synchronization item in a package is stored in the lastclock column.

```
create table sync_status
(
    peer text,
    priority integer,
    lastclock integer,
    primary key (
    peer,
    priority
  )
) ;
```

### Each replicated database typically also stores the latest values of clocks they are using and issuing.

Before the synchronization items are used they are generally reviewed to determine whether deferral may be needed for any field of the synchronization item. In this regard, the SQL triggers that generate the synchronization items may initially mark the synchronization items as private by setting the public field in the sync_event table to zero. The synchronization script may then go through each synchronization item, deferring any field of the item if needed. Once this step is completed, the synchronization script may then set the value of the public field to one so the synchronization items become available for synchronization.

Any large object that is marked for deferral in the publication may be processed, for example, using the two steps:
(1) the original synchronization item describing an INSERT or UPDATE statement that manipulates the row of the large object is replaced where the large object is substituted with its smaller representation according to the method of deferral that applies; and
(2) a new synchronization item is created which contains an UPDATE statement that will replace the small version with the original, large data object. This new synchronization item may be given a lower priority then the previous one.
   The synchronization script will then call the appropriate method of deferral (which may also be given in a form of a Python function) and will carry out the above mentioned steps using the result of the deferral method. As a result, the smaller representation will appear in a higher priority synchronization package, while the large representation will be part of a lower priority package.

Synchronization is generally a one-way operation where one peer propagates its synchronization state to another peer. The former peer is often referred as the source and the latter one is the destination peer. Naturally, after the synchronization is finished the roles can be interchanged so both can become aware of each other's modifications.

The processed described below follows the logic of the Python script, in accordance with one embodiment of the present invention. First, the source may check for any private items and defer them as necessary. The next step includes determining the maximum priority of the synchronization, i.e. only synchronization packages that have the same or lower number (higher importance) of priority will be sent to the destination. The priority is usually determined by the available connection, i.e. slower connections allow only the highest priority packages, although, as described above, the priority can be overridden if necessary in some embodiments of the present invention.

The script will then iterate through the source's sync_status table and for every synchronization package it will compare the lastclock value with the value seen by the destination. If there is no matching row in the destination's table it is assumed that the peer has not yet seen any items from that particular package. The synchronization packages are then processed in decreasing order of priority. This guarantees that the deferred items are put into the database correctly when both the small representations of the large items and large items themselves are transferred. In this case the large items have a lower priority thus it correctly replaces the previously entered smaller representation of the large item.

The synchronization items in one synchronization package are handled in the increasing order of clock value. Each synchronization item is transformed back to an SQL statement which is executed on the destination's database. During this process the SQL triggers of the destination's database are turned off so that the triggers do not generate any unnecessary synchronization info. The row of the synchronization item and its reference from the sync_event table is copied directly the synchronization tables of the destination.

When each synchronization package is processed the synchronization is completed. The script will enable the SQL triggers in the destination. The destination will then be able to propagate the received items to other peers. The synchronization items received by the destination device may not be the complete item set of the source device as this also depends on the selected synchronization priority. However, if all the items are transferred to the destination device, the destination will have the same knowledge of the deferred items as well.

In the above described exemplary embodiment, no new data should be entered into either database during the synchronization. On the source side, this ensures that the source's lastclock values will include only public items. On the destination side, the triggers are turned off during synchronization so any newly inserted data would not been seen by the synchronization process. For distributed primary key management embodiments of the system assign different intervals of keys to different peers. The distribution and auto incrementation of these primary keys may be handled by the synchronization SQL triggers acting on row insertion.

Although the above description generally describes a situation where a mobile terminal is synchronizing items with one database in another electronic device, in other embodiments, the mobile terminal may be configured to synchronize the same items with multiple databases or different items with different databases. As such, separate higher and lower priority queues may be maintained for each different database with which the mobile terminal is to synchronize. In one embodiment, queues may include another field describing the database to which the item is to be synchronized.

The functions described above with respect to the various embodiments of the present invention may be carried out in many ways. For example, any suitable means for carrying out each of the functions described above may be employed to carry out embodiments of the invention. According to one aspect of the present invention, all or a portion of the system of the present invention generally operates under control of a computer program product. The computer program product for performing the various processes and operations of embodiments of the present invention includes a computer-readable storage medium, such as a non-volatile storage medium, and computer-readable program code portions, such as a series of computer instructions, embodied in the computer-readable storage medium. For example, in one embodiment, the respective processors of the various electronic devices generally execute a database synchronization application in order to perform the various functions described above with reference to the various electronic devices, such as those functions shown in conjunction with FIGS. 4-6.

In this regard, FIGS. 4-6 are schematic illustrations, flowcharts, or block diagrams of methods, systems, devices, and computer program products according to embodiments of the present invention. It will be understood that each block of a flowchart or each step of a described method can be implemented by computer program instructions. These computer program instructions may be loaded onto a computer or other programmable apparatus to produce a machine, such that the instructions which execute on the computer or other programmable apparatus create means for implementing the functions specified in the described block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the described block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the described block(s) or step(s).

It will also be understood that each block or step of a described herein, and combinations of blocks or steps, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer program product for providing data synchronization between replicated databases in a first device and a second device, the computer program product comprising at least one computer-readable storage medium having computer-readable program code portions stored therein, the computer-readable program code portions comprising:
a first executable portion for determining a priority level for a synchronization item;
a second executable portion for determining a current state of the first device, wherein the current state comprises one of at least three possible states of the first device, the at least three possible states of the first device being at least partially based on a connection between the first device and the second device; and
a third executable portion for communicating the synchronization item from the first device to the second device based at least partially on the state of the first device and the priority level of the synchronization item.

2. The computer program product of claim 1, wherein the second executable portion is configured to determine the current state from among:
a first connection state where the first device is not connected to the second device;
a second connection state where the first device is connected to the second device using a first connection; and
a third connection state where the first device is connected to the second device using a second connection that is different than the first connection.

3. The computer program product of claim 2, wherein the current state of the device is based at least partially on the transmission rate of the connection between the first and second devices, and wherein the first connection has a lower transmission rate than the second connection.

4. The computer program product of claim 2, wherein the current state of the device is based at least partially on the cost of the connection between the first and second devices, and wherein the first connection has a higher cost than the second connection.

5. The computer program product of claim 2, wherein the first connection comprises using a first communication interface of the first device for connecting to a cellular network and wherein the second connection comprises using a second different communication interface for connecting to a wireless local area network.

6. The computer program product of claim 1, wherein the priority level is at least partially based on the size of the synchronization item.

7. The computer program product of claim 2, wherein the first executable portion comprises an executable portion for determining a priority threshold and for determining a relationship of the priority level of the synchronization item to the priority threshold in order to classify the synchronization item as being of a first priority or a second priority, wherein the third executable portion is configured to queue the synchronization item for communication using the first connection if the priority level indicates the first priority, and wherein the third executable portion is further configured to queue the synchronization item for communication using the second connection if the priority level indicates the second priority.

8. The computer program product of claim 7, wherein the first executable portion is configured to determine the priority level for the synchronization item by basing the priority level at least partially on the size of the synchronization item and then adjusting the priority level based on externally originated commands.

9. The computer program product of claim 9, wherein the priority threshold is determined based on externally originated commands.

10. The computer program product of claim 2, wherein the first executable portion comprises an executable portion for determining a priority threshold and for determining a relationship of the priority level of the synchronization item to the priority threshold in order to classify the synchronization item as being of a first priority or a second priority, wherein the third executable portion is configured so that the synchronization item is not communicated using the first connection if the priority level of the synchronization item indicates the first priority, and wherein the third executable portion is further configured so that the synchronization item is communicated using the first connection if the priority level of the synchronization item indicates the second priority.

11. The computer program product of claim 10, wherein the third executable portion is configured to communicate metadata related to the synchronization item using the first connection if the priority level of the synchronization item indicates the first priority.

12. The computer program product of claim 11, wherein the metadata comprises an abbreviated version of the synchronization item.

13. The computer program product of claim 10, wherein the third executable portion is configured so that the synchronization item is queued to be sent using the second connection if the priority level of the synchronization item indicates the first priority.

14. The computer program product of claim 10, further comprising a fourth executable portion for receiving input from an external entity, the input requesting communication of the synchronization item using the first connection, and for overriding the third executable portion such that the synchronization item is communicated using the first connection despite the fact that the priority level of the synchronization item indicated the first priority prior to receipt of the input.

15. The computer program product of claim 1, wherein the first device comprises a mobile terminal and the second device comprises a server.

16. The computer program product of claim 1, wherein the first device and the second device each comprise a mobile terminal.

17. A method for providing data synchronization between replicated databases in a first device and a second device, the method comprising:
determining a priority level for a synchronization item;
determining a current state of the first device, wherein the current state comprises one of at least three possible states of the first device, the at least three possible states of the first device being at least partially based on a connection between the first device and the second device; and
communicating the synchronization item from the first device to the second device based at least partially on the state of the first device and the priority level of the synchronization item.

18. The method of claim 17, wherein determining a current state of the first device comprises determining the current state from among:
a first connection state where the first device is not connected to the second device;
a second connection state where the first device is connected to the second device using a first connection; and
a third connection state where the first device is connected to the second device using a second connection that is different than the first connection.

19. The method of claim 18, wherein the current state is based at least partially on the type of the connection between the first and second devices, and wherein the first connection comprises a first type of connection that is generally slower and/or more expensive than a second type of connection that makes up the second connection.

20. The method of claim 18, wherein the first connection comprises using a first communication interface of the first device for connecting to a cellular network and wherein the second connection comprises using a second different communication interface for connecting to a wireless local area network.

21. The method of claim 17, wherein the priority level is at least partially based on the size of the synchronization item.

22. The method of claim 18, further comprising:
determining a priority threshold;
determining a relationship of the priority level of the synchronization item to the priority threshold in order to classify the synchronization item as being of a first priority or a second priority;
queuing the synchronization item for communication using the first connection if the priority level indicates the first priority; and
queuing the synchronization item for communication using the second connection if the priority level indicates the second priority.

23. The method of claim 22, wherein the determining of the priority level for the synchronization item comprises basing the priority level at least partially on the size of the synchronization item, and then adjusting the priority level based on externally originated commands.

24. The method of claim 18, further comprising:
determining a priority threshold;
determining a relationship of the priority level of the synchronization item to the priority threshold in order to classify the synchronization item as being of a first priority or a second priority;
preventing the communication of the synchronization item using the first connection if the priority level of the synchronization item indicates the first priority; and
communicating the synchronization item using the first connection if the priority level of the synchronization item indicates the second priority.

25. The method of claim 24, further comprising:
communicating metadata related to the synchronization item using the first connection if the priority level of the synchronization item indicates the first priority.

26. The method of claim 25, further comprising:
creating an abbreviated version of the synchronization item, wherein the communicating metadata comprises communicating the abbreviated version of the synchronization item.

27. The method of claim 24, further comprising:
receiving a request to from an external entity to communicate the synchronization item using the first data connection; and
communicating the synchronization item using the first connection despite the fact that the priority level of the synchronization item indicated the first priority prior to receipt of the input.

28. An apparatus comprising:
a memory for storing a replicated database and a synchronization item;
at least one communication interface for establishing a connection with an electronic device and for communicating the synchronization item to the electronic device; and
a processor operatively coupled to the memory and the communication interface, where the processor is configured to:
determine a priority level for the synchronization item;
determine a current state of the apparatus, wherein the current state comprises one of at least three possible states of the apparatus, the at least three possible states of the apparatus being at least partially based on the connection between the apparatus and the electronic device; and
communicate the synchronization item from the memory to the electronic device based at least partially on the current state of the apparatus and the priority level of the synchronization item.

29. The apparatus of claim 28, wherein the processor is configured to determine the current state from among:
a first connection state where the apparatus is not connected to the electronic device;
a second connection state where the apparatus is connected to the electronic device using a first connection; and
a third connection state where the apparatus is connected to the electronic device using a second connection that is different than the first connection.

30. The apparatus of claim 29, wherein the at least one communication interface comprises a first communication interface and a second different communication interface, wherein the first connection comprises using the first communication interface of the apparatus for connecting to a cellular network and wherein the second connection comprises using the second different communication interface for connecting to a wireless local area network.

31. The apparatus of claim 29, wherein the processor is configured to determine a priority threshold and to determine a relationship of the priority level of the synchronization item to the priority threshold in order to classify the synchronization item as being of a first priority or a second priority, wherein the processor is configured to queue the synchronization item for communication using the first connection if the priority level indicates the first priority, and wherein the processor is further configured to queue the synchronization item for communication using the second connection if the priority level indicates the second priority.

32. The apparatus of claim 29, wherein the processor is configured to determine a priority threshold and to determine a relationship of the priority level of the synchronization item to the priority threshold in order to classify the synchronization item as being of a first priority or a second priority, wherein the processor is configured to prevent communication of the synchronization item using the first connection if the priority level indicates the first priority, and wherein the processor is further configured to communicate the synchronization item using the first connection if the priority level of the synchronization item indicates the second priority.

33. The apparatus of claim 32, wherein the processor is configured to communicate metadata related to the synchronization item using the first connection if the priority level of the synchronization item indicates the first priority.

34. An apparatus for providing data synchronization between the apparatus and an electronic device, the apparatus comprising:
means for determining a priority level for a synchronization item;
means for determining a current state of the apparatus, wherein the current state comprises one of at least three possible states of the apparatus, the at least three possible states of the apparatus being at least partially based on a connection between the apparatus and the electronic device; and
means for communicating the synchronization item from the apparatus to the electronic device based at least partially on the state of the apparatus and the priority level of the synchronization item.

35. The apparatus of claim 34 further comprising:
memory means for storing a replicated database and a synchronization item; and
communication means for establishing at least one connection with the electronic device and for communicating the synchronization item to the electronic device.
